(19) United States
(12) Patent Application Publication
(10) Pub. No.: US 2025/0241815 A1
(43) Pub. Date: Jul. 31, 2025

(54) ANIMAL COFFIN WITH REMOVABLE MEMORIAL CONTAINER COMPRISING A PRE-SOWING COMPOSITION

(71) Applicant: Nidoo, Bordeaux (FR)

(72) Inventors: Laura Julie Iriart, Bordeaux (FR); Arthur Antoine Trichelieu, Bordeaux (FR)

(21) Appl. No.: 17/802,075

(22) PCT Filed: Feb. 25, 2021
(86) PCT No.: PCT/EP2021/054684

§ 371 Date: Feb. 3, 2023

(30) Foreign Application Priority Data
Feb. 26, 2020 (FR) FR20 01886
Feb. 26, 2020 (FR) FR20 01888

(51) Int. Cl. A61G 17/00

(52) U.S. Cl. CPC A61G 17/00

(57) ABSTRACT

Animal coffin, in particular for pets, comprising two half-shells, one lower (10I) and one upper (10S), one of the half-shells (10) comprising a housing (20), characterized in that it comprises a memorial container (22) comprising a composition for sowing plants or trees. Advantageously, the composition comprises a mixture of one or more seeds of plants or trees and a culture medium comprising dry fibers and potting soil, the composition being in the form of a compressed pellet.

### TECHNICAL FIELD

The invention relates to an animal coffin, in particular for pets, with a removable memorial container comprising a composition for sowing plants or trees. Advantageously, the composition comprises a mixture of one or more seeds of plants or trees and a culture medium comprising dry fibers and potting soil, the composition being in the form of a compressed pellet.

### PRIOR ART

Animal coffins are known which consist of two half-shells which can be connected by ties, once the remains of the animal have been placed in one of the shells. This type of coffin is preferably configured for small animals. The two half-shells are made of a biodegradable material, so that they can degrade over time without polluting the soil. Preferably, the two half-shells are made by thermo-molding from recycled cellulose sheet material, even more particularly from cellulose produced from recycled newspapers. The two half-shells are provided with ribs in order to confer to the whole assembly a certain mechanical rigidity allowing transport. The shape of the two half-shells is optimized to resist the push of the earth, said half-shells being of a rounded, ovoid shape.

Legislation requires that animal coffins be buried at a certain depth, in this case 1 m, to avoid any wild animal digging a hole to access the remains.

The owners of the animal often wish to mark the burial place, moreover to adorn the ground. The objective being to avoid creating pollution, a solution has been found by planning to grow plants at the location of the burial. The problem that arises is the depth of planting because the coffin is 1 m deep and the plants must be planted at a shallower depth of about ten centimeters. The solution found by the patentee is to propose providing a housing in one of the half-shells, in this case the upper half-shell, and to include in this housing compressed pellets containing the seeds of the plants to be grown.

The composition in the form of a compressed pellet is removed from the housing built into the upper half-shell, prior to burial. The coffin is placed in the ground and the removed soil is put back in place. The pellets are then planted in the loose soil at the burial site. The pellet is watered naturally or artificially if necessary and the composition containing the seeds, with the humidity of the ground, germinates and the plants grow at the location of the burial, thus ensuring that the site is marked.

The problem that arises is the period between the planting and the growth of the seeds, during which tracking is not possible. Moreover, another problem is the handling of the pellets, which are in raw form and may disintegrate depending on the storage conditions. Also, the seeds may be exposed to light and, depending on the ambient humidity, may germinate.

Compressed pellets, marketed under the name Jiffypot®, have been known since the 1950s, said pellets being formed by compressed, biodegradable peat pots. However, this type of pellet is not optimal and requires hydration before use. Trays comprising rock wool are also known, but are not satisfactory and require cutting after the germination of the plant. Moreover, rock wool is not suitable for all plants. This solution is therefore unsuitable for the container according to the present invention.

Lastly, pre-sowing and ready-to-use planting solutions are known, in particular marketed by the company MyHappyGarden®, which offers a capsule comprising three seeds, potting soil, and fertilizer. The range has so far been developed around tomato plants, vegetables, and aromatic herbs. However, this solution is not compressed, which facilitates the dispersion of the seeds after several waterings or due to the wind and is thus not optimal within the scope of the present invention.

The objective of the invention is to overcome these disadvantages and to propose a product suitable for burial in accordance with legislation and allowing the germination of plants at the burial site. Advantageously, the composition according to the invention is thus non-dispersible, derived from renewable raw materials, entirely biodegradable, non-toxic, environmentally friendly, easy to manufacture, handle, and store, and simple and quick to use.

### SUMMARY OF THE INVENTION

The present invention proposes to solve the problems posed. In response to these problems, the invention proposes an animal coffin, comprising two half-shells, one lower (10I) and one upper (10S), one of the half-shells (10) comprising a housing (20), characterized in that it comprises a memorial container (22) intended to be positioned removably in said housing (20), said memorial container comprising an inner volume (22-1) and a lid (22-2) associated with said inner volume and at least one predetermined breaking point intended to render the lid (22-2) integral with and detachable from said inner volume.

Said memorial container preferably comprises in its inner volume a composition 26 comprising a mixture of one or more seeds of at least one plant or at least one tree and a culture medium comprising dry fibers and potting soil, said composition being in the form of a compressed pellet.

The composition in the form of a compressed pellet is particularly advantageous for ensuring a maintained placement and for preventing the seeds from dispersing, even after several waterings, due to wind or other meteorological events.

Of course, the composition according to the invention is particularly suitable for use as a marker for a pet's burial site, said marker being materialized by the place of growth of the plant or tree present in said composition.

Further advantages and features of the invention will become apparent from the detailed description of the invention, from the examples, which are merely illustrative and by no means limit the scope of the invention, and from the illustrations which follow.

### BRIEF DESCRIPTION OF THE FIGURES

FIG. 1 shows a perspective view of the coffin as it appears, packaged for sale.

FIG. 2 shows an exploded view of the coffin in FIG. 1.

FIG. 3 shows a cross-section of the upper half-shell with its memorial container,

FIG. 4 shows a cross-sectional view of the placement of the various components of the coffin.

### DETAILED DESCRIPTION OF THE INVENTION

### Definition

The term “pellet” in the sense of the invention shall mean small blocks of various shapes and sizes, constituting the composition according to the invention. The pellet is characterized in particular in that it is compressed. For the purpose of the invention, the terms pellet, puck, tablet, capsule or nugget are used synonymously. The pellet is not necessarily circular, but may be of any other shape.

The term “culture medium” or “substrate” in the sense of the invention means a medium suitable for growing vegetation, particularly plants or trees. In particular, what is meant is a medium suitable for seed germination and therefore comprising all the minimum nutrients necessary for germination and development of the young plant.

The term “potting soil” in the sense of the invention means a natural culture support formed of topsoil enriched with decomposition products that provide organic matter.

The term “lean potting soil” in the sense of the invention means a potting soil that is sufficiently dry, characterized by a low moisture content and allowing the germinative capacity of the seed to be maintained. Thus, a moisture content of less than or equal to 50% is considered sufficiently dry to meet the needs of the present invention. Conversely, a potting soil is said to be rich when it is sufficiently moist to initiate germination.

The term “dry fibers” in the sense of the invention means natural, biodegradable, environmentally friendly fibers, characterized in that the fibers are capable of absorbing moisture.

The term “biodegradable” in the sense of the invention means a substance that can be totally or partially degraded by living organisms, in particular bacteria, so as to produce water, carbon dioxide and/or methane and possibly by-products such as residues or new biomass that are non-toxic for the environment.

### Device According to the Invention

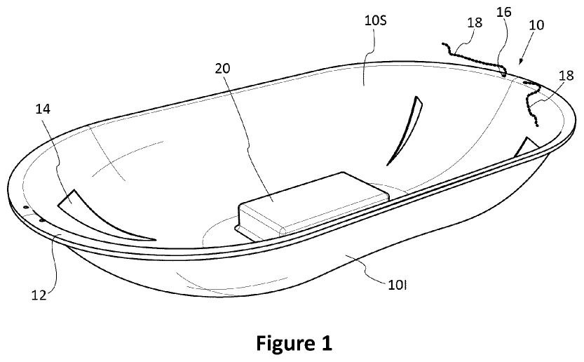

The coffin according to the present invention is described indifferently with respect to the various figures. FIG. 1 shows a lower half-shell 10I and an upper half-shell 10S.

Each half-shell 10 has a domed shape, advantageously achieved by thermoforming, more particularly from a biodegradable material. The periphery of each half-shell has a stiffening edge 12 and ribs 14 on the surfaces, intended to stiffen said half-shells 10. The half-shells 10 are of the same general exterior dimensions. Thus, when the shells 10 are oriented with the concave sides facing up or down, they can be nested one inside the other. The edges 12 come to rest on each other in the same direction. When the half-shells 10 are to be used to form a coffin, then one is turned over with respect to the other, see FIG. 4, so that the edges 12 come to face each other. Holes 16 are provided and a tie 18 is provided to hold one of the half-shells to the other half-shell, edge on edge.

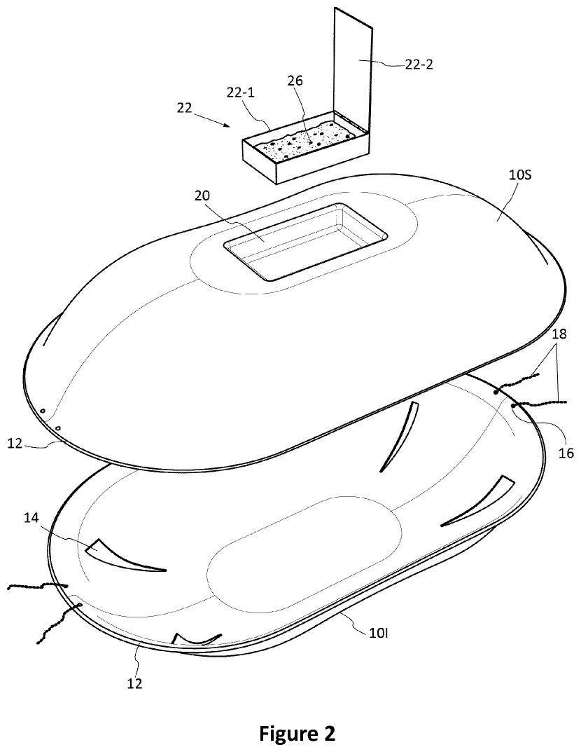

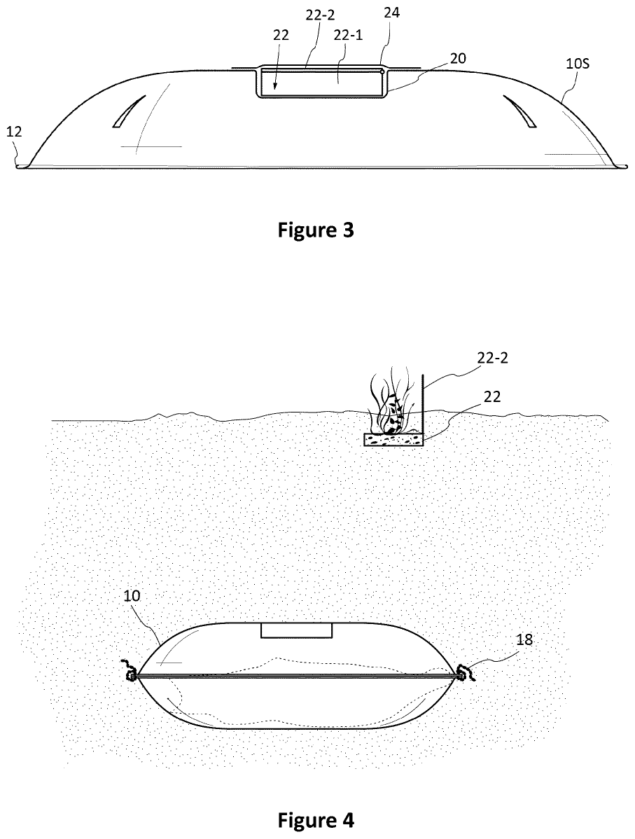

In FIGS. 2 and 3, the components of the coffin according to the present invention are shown and it can be seen that one of the half-shells, in this case the upper half-shell, comprises a housing 20 intended to receive a memorial container 22. This memorial container 22 is removable. A label 24, affixed above the housing 20 in an oversized manner, ensures that the memorial container 22 is held in place in said housing 20. This label is preferably opaque, so as to prevent the passage of light. This label 24 bears the commercial details, technical information for use, and also advice, as is usual.

The memorial container 22 includes an inner volume 22-1 and a lid 22-2 associated with said inner volume 22-1. The inner volume 22-1, which is parallelepipedic in shape with five sides in the embodiment shown, receives a composition in the form of a pellet 26, in which there are incorporated plant and/or tree seeds. The lid 22-2 is integral and hinged with respect to the inner volume, along one edge of said parallelepipedic volume, and constitutes the sixth face of the parallelepipedic shape. It is understood that the memorial container retained, of parallelepipedic shape, may be of any other shape, in particular an oblong shape with homothety of the shape of the coffin itself. Advantageously, the integral lid is glued on the periphery or clipped on the edge of the inner volume 22-1 so as to avoid any untimely opening. Once the lid has been opened, said lid can be kept connected and hinged or can be detached from the five-sided container, with one or more predetermined breaking points being provided advantageously. The memorial container 22 is made of biodegradable material which may be identical to the material used to thermoform the half-shells, but may also be made of biodegradable material with a longer shelf life before degradation. The material constituting the lid may allow for the application of an epitaph type of writing using common writing means, such as a marker pen.

It should also be noted that, independently of the shape of the memorial container, the lid 22-2 may also not be integral with the inner volume 22-1, but simply glued by its periphery to the edge of the inner volume 22-1 and thus fitted over it, or clipped on, or held in place by spiked protrusions at the edges of the container and the lid, all of these embodiments being completely equivalent to a lid that is integral and detachable by means of perforated lines, for example. Alternatively, the lid (22-2) may also include a connection to the internal volume (22-1) with a precut, so as to make it detachable. In the case of an associated and non-integral lid 22-2, the material may be different from that of the inner volume 22-1 so as to provide a longer life span, while still being biodegradable.

As shown in FIG. 4, the coffin according to the present invention is used as follows. The animal body is placed in the lower half-shell 10I, with a non-woven fabric if necessary in order to absorb liquids. The upper half-shell 10S is attached to the lower half-shell 10I. The tie 18 is then passed through the holes 16 formed in the two half-shells to ensure the connection between the two shells. The coffin and the animal body contained therein can be moved, transported, to the place of burial.

When the coffin is to be placed in the ground in a hole provided for this purpose, the necessary depth having been observed, the label 24 attached to the upper side of the upper half-shell is removed or will have been removed beforehand. The removal of the label, when present, provides access to the memorial container 22. The memorial container 22 is then removed from the housing 20 of the upper half-shell 10S. The coffin and animal body therein can be placed in the ground and the hole is filled in.

The memorial container 22 is opened in order to arrange the lid 22-2 in a position perpendicular to the plane of the inner volume 22-1, like an upright wall, in a first variant. The inner volume 22-1 with its composition in the form of a pellet 26 and its seeds is planted in the loosened soil, at a suitable depth, on the order of 10 cm to give an idea, preferably between 0.1 cm and 5 cm. In fact, the lid 22-2 is maintained in its perpendicular position during the shallow planting. The lid thus protrudes above ground level. The location of the burial can thus be marked, and if the lid has been written on beforehand, both identity and location can be provided. The advantage of keeping the lid 22-2 connected to the inner volume is that, in regions subject to strong winds, the lid is still fixed to the inner volume, which, once planted, does not move.

According to another variant, the lid 22-2 is cut and detached from the inner volume 22-1 so that the inner volume 22-1 with its composition in the form of a pellet comprising the substrate and its seeds can be planted at the rear of the burial site, for example, while the lid 22-2 can be sunk into the earth at the other end of the burial site.

It is therefore possible to locate the burial site at any time, including in the period before germination and development of the plants. Once the plants have developed, locating the site is easy. For this reason, the material of the memorial container 22 may be different from that of the half-shells 10, with a slower degradability than that of the material of the half-shells. The material can also be completely identical for the entire kit, but the material of the memorial container 22 can undergo, at least on a part of its surface, in particular the lid or at least a part of the lid, a particular treatment such as the application of hydrophobic products, for example natural wax or hydrophobic products having no influence on the environment.

The materials will biodegrade over time and the plants will grow, marking the burial site. It is also noted that the use of the container and its handling remain simple, without the risk of the composition in the form of a pellet 26 being broken or spilled. The memorial container 22 can be removed easily from the housing 20 of the half-shell which carries it.

Thus, the invention also relates to an animal coffin, characterized in that the inner volume 22-1 comprises a composition in the form of a pellet 26 comprising a mixture of one or more seeds of at least one plant or at least one tree and a culture medium or substrate comprising dry fibers and potting soil, the composition being in the form of a compressed pellet, characterized in that the moisture content of the potting soil is less than or equal to 50%.

### Composition According to the Invention

The composition in the form of a pellet 26 comprises a mixture of one or more seeds of at least one plant or at least one tree and a culture medium or substrate comprising dry fibers and potting soil, the composition being in the form of a compressed pellet. The pellet may or may not be circular in shape.

Preferably, the invention relates to a composition 26 comprising a mixture of one or more seeds of at least one plant or at least one tree and a culture medium comprising dry fibers selected from corncob, coconut fiber, dry peat, hemp shiv, and dried wood fiber; and potting soil, the composition being in the form of a compressed pellet, characterized in that the moisture content of the potting soil is less than or equal to 50%.

The composition in the form of a compressed pellet is particularly advantageous for ensuring a maintained placement and preventing the seeds from dispersing, even after several waterings, due to wind or other meteorological events.

In particular, the potting soil in the culture medium according to the invention is a lean potting soil, making it possible to maintain the composition and in particular the seeds in an environment sufficiently dry so as not to initiate germination of the seeds before use of the product. The term “seed” in the sense of the invention means, indifferently, one seed or multiple seeds. Thus, when the term “seed” is used in the singular, it should also be understood in the plural, and vice versa.

Preferably, the lean potting soil is characterized by a moisture content less than or equal to 50%. Beyond that, the potting soil is too wet and therefore too rich, initiating seed germination before use or during storage of the pellets. Particularly preferably, the lean potting soil is characterized by a moisture content of less than or equal to 30%.

In addition to the presence of potting soil, the composition comprises dry fibers capable of absorbing moisture during use of the pellet, particularly when the pellet is buried and moistened to initiate the germination process. The dry fibers according to the present invention also make it possible to avoid excess water from being retained, which would cause the seed or the developing root system to rot, ultimately resulting in the death of the young plant. In this sense, the culture medium preferably comprises fibers selected from corncob, coconut fiber, dry peat, hemp shiv, and dried wood fiber. Particularly preferably, comcob is selected for its intrinsic qualities, including its moisture absorption capabilities and hypoallergenic qualities, its availability, and its ease of use in the context of the present invention.

Preferably, the moisture content of the composition is less than or equal to 50%. Thus, the moisture content in the memorial container 22 remains low and prevents germination before planting.

According to a preferred object, the composition according to the invention consists of a homogeneous mixture of the seeds and the culture medium, the latter being in turn a homogeneous mixture of the potting soil and the dry fibers.

In order to meet the needs of the invention and to respect the diversity of plant or tree seeds, the culture medium preferably comprises between 30% and 70% by weight of dry fibers in relation to the total weight of the culture medium. Even more preferably, the culture medium comprises at least 35%, 40%, 45%, 50%, 55%, 60% or 65% and not more than 70% by weight of dry fibers in relation to the total weight of the culture medium.

Therefore, the culture medium preferably comprises between 30% and 70% by weight of lean potting soil in relation to the total weight of the culture medium. Even more preferably, the culture medium comprises at least 35%, 40%, 45%, 50%, 55%, 60% or 65% and not more than 70% by weight of lean potting soil in relation to the total weight of the culture medium.

According to a particularly preferred object of the composition, the culture medium comprises 50% by weight of dry fiber and 50% by weight of potting soil in relation to the total weight of the culture medium.

In order to meet the needs of storage, preservation and holding, the composition according to the invention is compressed. A composition provided as a compressed pellet greatly facilitates handling by an operator or user because of its form and strength. The composition in compressed pellet form is obtained by compressing and compacting the composition and binding it. Thus, the compressed form keeps for longer, is robust, and can be of different shapes. Preferably, the pellet is compressed to a value of 50 Newton (N) or less. A compression lower than or equal to 50 N makes it possible to maintain the structure of the seed and thus to preserve its germinative capacities while keeping a culture medium sufficiently aerated to allow the germination and the development of the root and foliar system.

Preferably, the compressed pellet does not swell or swells only slightly after rehydration. Preferably, the volume of the hydrated pellet is therefore identical to or at most 200% of the volume of the dehydrated pellet within the measurement uncertainties.

Advantageously, the composition in the form of a compressed pellet is entirely biodegradable.

In a particularly preferred manner, the composition according to the invention does not comprise any net or membrane for maintaining the very structure of the composition in the form of a pellet. Indeed, the compressed pellet does not require a net to maintain its shape during rehydration due to the fact that the pellet does not swell or only slightly swells when rehydrated. Thus, the structure and form of the rehydrated pellet are unchanged. A slight variation, especially a slight increase, in the volume of the hydrated pellet will not destructure said pellet.

According to another object of the invention, the composition comprises a mixture of one or more seeds of plants, trees and mixtures thereof representing between 1% and 20% by weight of the total weight of the composition. Of course, a person skilled in the art will be able to adapt the amount of seed depending on the type of seed chosen.

Preferably, the composition according to the invention comprises between 10 and 30 seeds of a species of plants, trees and mixtures thereof.

The compressed pellet may also comprise, on the upper part, a water-soluble, standard label or a lid made of cardboard, cellulose, or paper. The label, in addition to containing information about the type of seeds present in the pellet, makes it possible to shield the mixture of seeds from light and thus prevent germination.

Preferably, the weight of the compressed pellet comprising said composition according to the invention is less than or equal to 150 g, preferably 100 g.

According to another aspect, the invention also relates to a method for producing said composition, the method comprising the following steps:
mixing the seeds and the culture medium,
arranging the mixture in a mold of the desired shape, and
compacting the mixture, preferably at a compression value less than or equal to 50 N.

According to one embodiment, the mold used may be the final container comprising said composition according to the invention.

The composition according to the invention is intended to be used in order to be buried below a depth of soil between 0.1 cm and 5 cm. Such a depth of burial is satisfactory to meet the germination needs of most plant or tree seeds. Preferably, the composition is buried under 1 cm of soil.

The composition according to the invention is thus particularly suitable for use as a marker for a pet's burial site, said marker being materialized by the place of growth of the plant or tree present in said composition.

According to another aspect, the composition according to the invention is contained in a pet burial device, in particular in a memorial container. Said animal burial device is an animal coffin, in particular for pets, comprising two half-shells, specifically a lower and an upper half-shell, one of the half-shells comprising a housing, characterized in that it comprises a memorial container intended to be removably positioned in said housing, said memorial container comprising an inner volume and a lid integral with said inner volume.

1. An animal coffin, comprising two half-shells, one lower (10I) and one upper (10S), one of the half-shells (10) comprising a housing (20), characterized in that it comprises a memorial container (22) intended to be removably positioned in said housing (20), said memorial container comprising an inner volume (22-1) and a lid (22-2) associated with said inner volume and predetermined breaking points intended to render the lid (22-2) integral with and detachable from said inner volume.

2. The animal coffin according to claim 1, characterized in that the memorial container (22) is made of biodegradable material.

3. The animal coffin according to claim 1, characterized in that the lid (22-2) is made of a material different from that of the inner volume (22-1).

4. The animal coffin according to claim 1, characterized in that at least the lid (22-2) undergoes, at least on a part of its surface, a hydrophobic treatment.

5. The animal coffin according to claim 1, characterized in that the inner volume (22-1) comprises a composition (26) comprising a mixture of one or more seeds of at least one plant or at least one tree and a culture medium comprising dry fibers selected from corncob, coconut fiber, dry peat, hemp shiv, and dried wood fiber; and potting soil, the composition being in the form of a compressed pellet, characterized in that the moisture content of the potting soil is less than or equal to 50%.

6. The animal coffin according to claim 1, characterized in that the lean potting soil comprises a moisture content of less than 30%.

7. The animal coffin according to claim 5, characterized in that the dry fibers are corncob.

8. The animal coffin according to claim 5, characterized in that the moisture content of the composition is less than 50%.

9. The animal coffin according to claim 5, characterized in that the culture medium comprises between 30% and 70% by weight of dry fiber in relation to the total weight of the culture medium.

10. The animal coffin according to claim 5, characterized in that the culture medium comprises between 30% and 70% by weight of potting soil in relation to the total weight of the culture medium.

11. The animal coffin according to claim 5, characterized in that the culture medium comprises 50% by weight of dry fiber and 50% by weight of potting soil in relation to the total weight of the culture medium.

12. The animal coffin according to claim 5, characterized in that the pellet is compressed to a value less than or equal to 50 Newton.

13. The animal coffin according to claim 1, characterized in that it comprises a label (24), affixed above the housing (20) in an oversized manner, with the memorial container (22) in place in said housing (20).

14. The animal coffin according to claim 1, characterized in that the material constituting the memorial container (22) is different from the material from which the half-shells (10) are made.
